(19) United States
(12) Patent Application Publication
(10) Pub. No.: US 2023/0371031 A1
(43) Pub. Date: Nov. 16, 2023

(54) CONTROL CHANNEL FOR REDUCED CAPABILITY DEVICE

(71) Applicant: Sony Group Corporation, Tokyo (JP)

(72) Inventors: Basuki PRIYANTO, Lund (SE); Nafiseh MAZLOUM, Lund (SE); Johan HILL, Lund (SE)

(21) Appl. No.: 18/030,059

(22) PCT Filed: Sep. 23, 2021
(86) PCT No.: PCT/EP2021/076212

§ 371 Date: Apr. 3, 2023

(30) Foreign Application Priority Data
Oct. 16, 2020 (SE) 2030311-1

(51) Int. Cl. H04W 72/23

(52) U.S. Cl. CPC H04W 72/23; H04W 88/08

(57) ABSTRACT

Examples provide a method of operating an access node comprising broadcasting, by the AN, a message indicative of resources for transmitting a control channel, wherein the message is indicative of first resources and second resources for transmitting the control channel, wherein the first resources are associated with a first wireless device type, and wherein the second resources are associated with a second wireless device type, which has reduced capabilities in relation to the first wireless device type; and transmitting, by the AN, the control channel using the first resources and the second resources. Further examples provide a corresponding method of operating a wireless communication device, a corresponding access node and a corresponding wireless communication device.

### TECHNICAL FIELD

Examples relate to communication between an access node and wireless communication devices.

### BACKGROUND

Physical layer procedures for control as specified by the technical specification 3GPP TS 38.213 V16.3.0 (2020-09) of the 3rd Generation Partnership Project (3GPP) provide for control channels comprising scheduling and paging information to be used by wireless communication devices, wherein the wireless communication devices operate in frequency range 1 (FR1) and/or frequency range 2 (FR2) of the radio access technology (RAT) 5G NR as developed by the 3GPP for the 5G mobile network. FR1 includes sub-6 GHz frequency bands and FR2 includes frequency bands in the mmWave range (24-100 GHz).

To comply with the known specification, wireless communication devices have to support a certain maximum bandwidth to receive the essential signals/channels, including control channels. Wireless communication devices have to support a certain antenna configuration to fulfil certain performance. New use cases may come along with wireless communication devices, e.g. sensors or wearable, not being able to comply with these bandwidth, hardware processing capacity, and/or antenna configuration requirements.

### SUMMARY

Accordingly, there may be a need of improved techniques for operating known wireless communication devices in a communication network together with wireless communication devices, which are band limited, limited hardware processing capacity, and/or have a different antenna configuration in relation to the known wireless communication devices.

Said need is addressed with the subject-matter of the independent claims. The dependent claims define advantageous examples.

Examples provide a method of operating an access node comprising broadcasting, by the AN, a message indicative of resources for transmitting a control channel, in particular a control channel associated with a communication standard (e.g., NR and/or 6G), wherein the message is indicative of first resources and second resources for transmitting the control channel, wherein the first resources are associated with a first wireless device type, and wherein the second resources are associated with a second wireless device type, which has reduced capabilities in relation to the first wireless device type; and transmitting, by the AN, the control channel using the first resources and the second resources.

Further examples provide a method of operating a wireless device comprising receiving, from an access node a message indicative of resources for receiving a control channel, in particular a control channel associated with a communication standard (e.g. NR and/or 6G), wherein the message is indicative of first resources and second resources for receiving the control channel, wherein the first resources are associated with a first wireless device type (Legacy UE), and wherein the second resources are associated with a second wireless device type, which has reduced capabilities in relation to the first wireless device type; monitoring the first resources if the wireless device implements a first wireless device type; and monitoring the second resources if the wireless device implements a second wireless device type.

Additional examples provide an access node comprising circuitry configured for causing the AN to broadcast a message indicative of resources for transmitting a control channel, in particular a control channel associated with a communication standard (e.g. NR and/or 6G), wherein the message is indicative of first resources and second resources for transmitting the control channel, wherein the first resources are associated with a first wireless device type, and wherein the second resources are associated with a second wireless device type, which has reduced capabilities in relation to the first wireless device type; and to transmitting the control channel using the first resources and the second resources.

Still further examples provide a wireless communication device comprising circuitry configured for causing the UE to receive, from an access node, AN, a message indicative of resources for receiving a control channel, in particular a control channel associated with a communication standard (e.g. NR and/or 6G), wherein the message is indicative of first resources and second resources for receiving the control channel, wherein the first resources are associated with a first wireless device type, and wherein the second resources are associated with a second wireless device type, which has reduced capabilities in relation to the first wireless device type; to monitor the first resources if the wireless device implements a first wireless device type; and to monitor the second resources if the wireless device implements a second wireless device type.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a wireless communication system;

FIG. 2 illustrates signalling for indicating resources for transmitting a control channel;

FIG. 3 schematically illustrates resources for transmitting a control channel;

FIG. 4 schematically illustrates resources for transmitting a control channel;

FIG. 5 schematically illustrates resources for transmitting a control channel;

FIG. 6 schematically illustrates resources for transmitting a control channel;

FIG. 7 schematically illustrates resources for transmitting a control channel;

FIG. 8 schematically illustrates resources for transmitting a control channel;

FIG. 9 schematically illustrates resources for transmitting a control channel;

FIG. 10 schematically illustrates resources for transmitting a control channel;

FIG. 11 schematically illustrates resources for transmitting a control channel and a data channel; and

FIG. 12 schematically illustrates resources for transmitting a control channel and data channels;

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between communication nodes. In some examples, the wireless communication system can be implemented by a wireless communication network, e.g., a radio-access network (RAN) of a Third Generation Partnership Project (3GPP)-specified cellular network (NW). In such case, one communication node can be implemented by a base station (BS) of the RAN, and one or more further communication nodes can be implemented by wireless devices (also referred to as user equipment, UE).

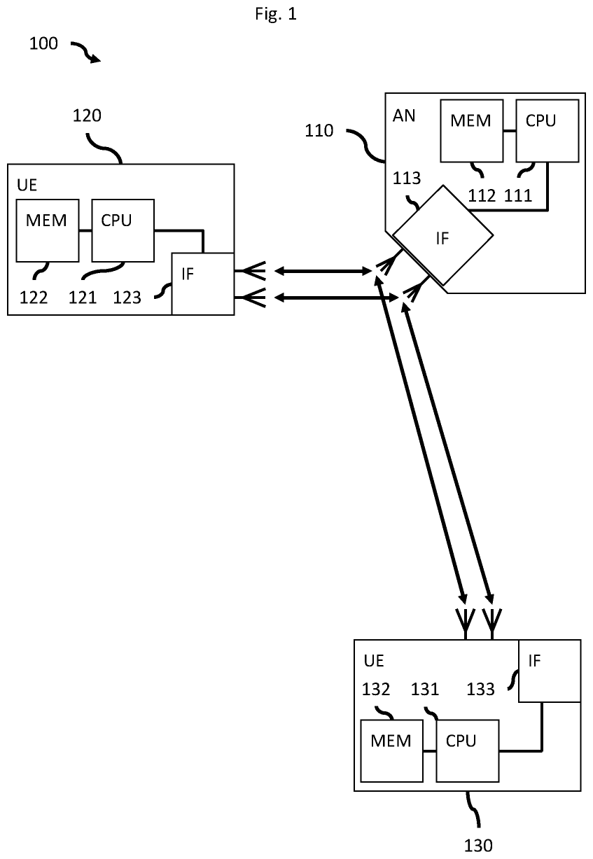

FIG. 1 shows a wireless communication network 100 comprising an access node (AN) 110, a first wireless communication device 120, and a second wireless communication device 130.

The access node 110 may include control circuitry 111, memory circuitry 112, in particular non-volatile memory, and interface circuitry 113. The interface circuitry 113 may be adapted for controlling transmission/reception of wireless signals via one or more antennas. The control circuitry 111 may be implemented by a processor. The processor may be configured to load program code that is stored in the memory circuitry 112. The processor may than execute the program code. Executing the program code may cause the processor to perform techniques described herein.

Correspondingly, the first wireless communication device 120 may include control circuitry 121, memory circuitry 122, in particular non-volatile memory, and interface circuitry 123. The interface circuitry 123 may be adapted for controlling transmission/reception of wireless signals via one or more antennas. The control circuitry 121 may be implemented by a processor. The processor may be configured to load program code that is stored in the memory circuitry 122. The processor may than execute the program code. Executing the program code may cause the processor to perform techniques described herein. Similarly, the second wireless communication device 130 may include control circuitry 131, memory circuitry 132, in particular non-volatile memory, and interface circuitry 133. The interface circuitry 133 may be adapted for controlling transmission/reception of wireless signals via one or more antennas. The control circuitry 131 may be implemented by a processor. The processor may be configured to load program code that is stored in the memory circuitry 132. The processor may than execute the program code. Executing the program code may cause the processor to perform techniques described herein.

The first wireless communication device 120 is of a first wireless device type and the second wireless communication device 130 is of a second wireless device type. The second wireless device type has reduced capabilities in relation to the first wireless device type. In particular, the second wireless device type may be a band limited type. For example, wireless communication devices according to the second wireless device may only support a limited bandwidth. In further examples, wireless communication devices according to the second wireless device may have limited processing capability in both radio frequency (RF) and/or baseband. Alternatively or in addition, the number of antennas of a wireless communication device according to the second wireless device type may be limited and/or the antenna size may be smaller and/or the configuration of the antenna may be subject to constraints and not optimal. This may influence the antenna gain for transmission and reception.

During initial access and after cell search and synchronization the wireless communication device 120 may receive a message indicative of first resources for receiving a control channel. For example, the wireless communication device 120 may receive as massage in an SS/PBCH block (synchronization signal physical broadcast channel) also known as SSB as specified in 3GPP TS 38.213 V16.3.0. The message may comprise a field for the first resources for receiving a control channel. The message may be a MIB (master information block) parameter transmitted in the SS/PBCH block. For example, the MIB may include an RMSI-PDCCH-Config as described in 3GPP TS 38.213 V16.3.0. The four most significant bits of the RMSI-PDCCH-Config may correspond to a field indicating a control resource set (CORESET) as specified in 3GPP TS 38.213 V16.3.0. The CORESET is a set of physical resources (e.g., a specific area of a NR downlink resource grid) that is used to carry a physical downlink control channel (PDCCH). The CORESET may correspond to the first resources for receiving the control channel and the control channel may correspond to the PDCCH. Exemplary first resources for receiving the control channel may be specified in tables 13-1 through 13-10 of 3GPP TS 38.213 V16.3.0.

In addition, the message indicative of the first resources for receiving the control channel may also be indicative of a time domain location of the first resources. The time domain location may correspond to monitoring occasions in which the first wireless communication device 120 is to monitor the first resources for receiving the control channel. For example, the four least significant bits of the RMSI-PDCCH-Config as described hereinbefore may correspond to a field indicating the monitoring occasions. Tables 13-11 through 13-15 of 3GPP TS 38.213 V16.3.0 may be used for interpreting the field indicating the monitoring occasions.

Table 13-1 prescribes that for an index 14, 96 resource blocks resource blocks is to be used for the first resources for resource elements having a subcarrier spacing (SCS) of 15 kHz. Accordingly, for 96 resource blocks each comprising 12 resource elements and each resource element using a subcarrier spacing of 15 kHz, a bandwidth of 96*12*15 kHz=17.280 MHz has to be supported by the first wireless communication device for monitoring the first resources if the first wireless communication device is to operate in FR1 and the index according to the RMSI-PDCCH-Config is 14. For different indexes, supporting a smaller bandwidth can be sufficient.

Table 13-7 prescribes that for an index 7, 96 resource blocks is to be used for the first resources for resource elements having an SCS of 60 kHz. Accordingly, for 96 resource blocks each comprising 12 resource elements and each resource element using an SCS of 60 kHz, a bandwidth of 96*12*60 kHz=69.120 MHz has to be supported by the first wireless communication device for monitoring the first resources if the first communication device is to operate in FR2 and the index according to the RMSI-PDCCH-Config is 7. For different indexes, supporting a smaller bandwidth can be sufficient.

Table 13-8 prescribes that for an index 6, 48 resource blocks and an offset of −20 resource blocks relative to SSB is to be used for the first resources for resource elements having an SCS of 120 kHz. Furthermore, SSB and CORESET multiplexing pattern is 3 or known as using Frequency Division Multiplexing (FDM). Hence, the first wireless communication device requires a simultaneous reception of SSB and

CORESET. Accordingly, for CORESET with 48 resource blocks each comprising 12 resource elements and each resource element using an SCS of 120 kHz, and for SSB with 20 resource blocks each comprising 12 resource elements and each resource element using an SCS of 120 kHz, a bandwidth of (48*12*120 kHz)+(20*12*120 kHz)=97.920 MHz has to be supported by the first wireless communication device for monitoring the first resources if the first communication device is to operate in FR2 and the index according to the RMSI-PDCCH-Config is 6. For different indexes, supporting a smaller bandwidth may be sufficient.

As explained before, the second wireless communication device 130 may have reduced capabilities.

In examples, the second wireless communication device 130 may be band limited. For example, the second wireless communication device 130 may only support a maximum bandwidth of up to 50 MHz when operating in FR2. Thus, the second wireless communication device 130 may not be able to monitor the first resources for receiving the control channel as the required minimum bandwidth of 69.120 MHz or 97.920 MHz is exceeding the maximum bandwidth of 50 MHz supported by the second wireless communication device 130.

Alternatively or in addition, the second wireless communication device 130 may have a number and/or configuration and/or size of antennas leading to a reduced antenna gain for transmission and/or reception of signals. Accordingly, the total number of 288 resource blocks (96 consecutive resources blocks in frequency domain*3 consecutive symbols in time domain) as specified in table 13-1 may not be sufficient for reliably transmitting the control channel. For example, a higher aggregation level or repetition rate may be required for reliably transmitting the control channel which may not be possible using the (limited) first resources according to the known communication standard. The second wireless communication device 130 may need to receive longer signals, for coverage recovery purposes, before it can decode/detect them. The first resources associated with the known first wireless device type may not be sufficient to map/include the longer signal required for wireless communication devices of the second wireless device type.

To address these challenges associated with wireless communication devices of a second device type having reduced capabilities, it is proposed that the message is also indicative of second resources for receiving, by the second wireless communication device 130, the control channel. After broadcasting the message indicative of resources for transmitting a control channel, the access node may transmit the control channel using the first resources and the second resources. The control channel may be associated with a communication standard and/or communication protocol or specification. In particular, the control channel may be associated with a NR communication standard as specified by 3GPP.

In contrast to known techniques used in the context of Internet of Things (IoT) and machine type communication (MTC) (for example, NB-IoT and LTE-M as specified by 3GPP), the wireless communication devices of the first wireless device type and the second wireless device type may implement the same communication standard. Both the first wireless device type and the second wireless device type may use the same communication standard and/or communication protocol. For example, the wireless communication devices of the first wireless device type and the second wireless device type may both implement a NR standard as specified by the 3GPP. In examples, the wireless communication devices of the first wireless device type and the second wireless device type may use the very same frequency band for communication with the access node. In case the wireless communication devices of the first wireless device type and the second wireless device type both implement a NR standard as specified by the 3GPP, the wireless communication devices of the first wireless device type and the second wireless device type may both use the frequency band FR1 and/or FR2. In particular, the proposed method may be used for wireless communications devices of a second wireless device type called “reduced capability NR devices” as specified in 3GPP contribution “Revised SID on Study on support of reduced capability NR devices”, document RP-201386, 3GPP TSG RAN Meeting #88e.

A wireless communication device of the second wireless device type may report its capabilities to the access node, which may allocate resources for further communication between the access node and wireless communication device of the second wireless device type according to the known communication standard taking into account the (reduced) capabilities of the second wireless device type. Thus, minimal changes to the known communication system are required to support also wireless communication devices of the second wireless device type. In particular, no changes may be required for wireless communication devices of the first wireless device type. In particular, the proposed method may be implemented in established communication networks.

In examples, the message may comprise a field for the first resources and an additional field for the second resources. Thus, the first resources and the second resources used by the access node to transmit the control channel may be selected independently from one another. For example, the field for the first resources may indicate that the first resources consist of 48 consecutive resources blocks in frequency domain and 2 consecutive symbols in time domain and the additional field for the second resources may indicate independently that the second resources consist of 96 (or 144) consecutive resource blocks in frequency domain and 2 (or 8) consecutive symbols in time domain. It may also be possible that the additional fields specified that the second resources consist of x times the consecutive resource blocks in frequency domain specified for the first resources (e.g., x*48 resources blocks=144 resources blocks for x=3) and y times the consecutive symbols specified for the second resources (e.g., y*2 symbols=8 symbols for y=4).

In other examples, one field of the message may be used for both the first resources and the second resources. The one field of the message may be interpreted differently by wireless communication devices of the first device type and wireless communication devices of the second device type based on a predefined interpretation rule. For example, different tables for interpreting the one filed may be used by wireless communication devices of the first device type and wireless communication devices of the second wireless device type. It is also possible that the second resources always relate to a given multiple of the first resources. For example, if the field indicates 48 consecutive resource blocks and 2 consecutive symbols to be used as first resources, wireless communication devices of a second device type that x*48 consecutive resource blocks and y*2 consecutive symbols are to be used as second resources, wherein x and y are predefined values known to the wireless communication devices of the second device type.

This may substantially reduce the overhead for transmitting the information on the first and second resources from the access node to the wireless communication devices. For example, the known SS/PBCH block with very limited size may be used to transmit the information on the first and second resources.

The first and second wireless communication devices may both receive the very same message indicative of resources for receiving a control channel associated with a communication standard. The same message may point to different resources using different interpretation rules depending on device capability. In example, the communication standard may be a New Radio (NR) communication standard as specified by 3GPP. The message may also be considered as being a broadcast message.

As explained, the message may be indicative of first resources and second resources for receiving the control channel. The first wireless communication device implementing a first wireless device type may monitor the first resources and the second wireless communication device implementing a second wireless device type may monitor the second resources. Thus, it may be possible to receive the same control channel by a legacy wireless communication device and a wireless communication device having limited capabilities.

In examples, it may also be possible that a wireless communication device may implement the first device type and the second device type according to a predetermined criteria. For example, reduced capabilities may go along with reduced power consumption. Thus, if the remaining battery capacity of the wireless communication device falls below a certain threshold, the wireless communication device may select to implement a second wireless device type having reduced capabilities. For example, the wireless communication device may select to support only a limited bandwidth and still be able to receive the control channel.

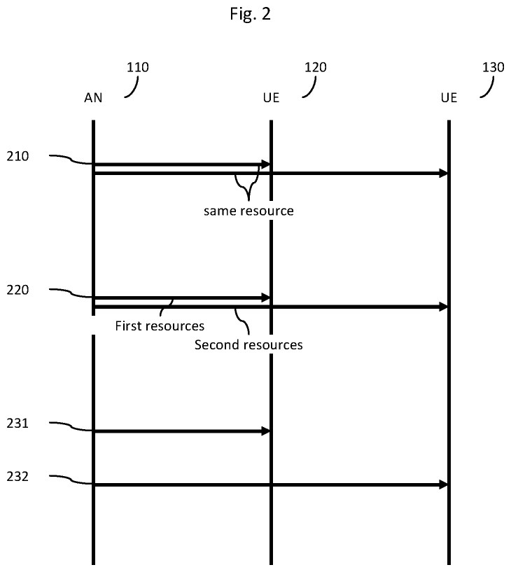

FIG. 2 is a signaling diagram illustrating the communication between the access node 110, the first wireless communication device 120 and the second wireless communication device 130.

The access node broadcasts a message 210 indicative of resources for transmitting a control channel associated with a communication standard. The first wireless communication device 120 and the second wireless communication device 130 may receive the message.

The message 210 is indicative of first resources and second resources for transmitting the control channel 220, wherein the first resources are associated with a first device type and the second resources are associated with a second device type. In other words, message 210 enables a receiving wireless communication device to determine first resources and second resources for receiving the control channel 220. The second resources may occupy a narrower frequency band in relation to the first resources depending on the configuration. In addition or alternatively, the second resources may occupy a longer time in relation to the first resources depending on antenna configuration of the second device in relation to the first wireless device.

The first wireless communication device 120 implementing the first wireless device type may monitors the first resources and the second wireless communication device 130 implementing the second device type may monitor the second resources.

The access node 110 may transmit the control channel 220 using both the first resources and the second resources. In other words, if the access node 110 (e.g., a base station) has control information to send to wireless communication devices of both the first and second device type (e.g. broadcast control information), or if the access node 110 is unware of the device type of the wireless communication device, the access node sends the very same control channel, i.e., the very same control information, using the first resources and the second resources. For example, the control information may transmitted on first resources which a legacy wireless communication device is able to monitor and on second resources which a wireless communication device having reduced capabilities is able to monitor.

The first wireless communication device 120 may receive the control channel 220 on the first resources. The second wireless communication device may receive the control channel 220 on the second resources.

The control channel 220 may comprise a configuration of a first data channel 231. The configuration may be downlink control information (DCI) as specified by 3GPP. Data to be transmitted on a data channel (e.g. a physical download shared channel (PDSCH)) may be scheduled on the control channel. In addition, the control channel 220 may comprise a configuration of a second data channel. The configuration of the first and/or second data channel may be indicative of at least one of a physical resource used for transmitting data on the first data channel 231 and/or for transmitting data on the second data channel 232 and a modulation scheme used for transmitting data on the first data channel 231 and second data channel 232. The first data channel 231 and the second data channel 232 may be identical.

According to examples, an aggregation level concept may be used to improve the robustness of the transmission of a control channel. Depending on an aggregation level, one or more control channel elements (CCE) may be used.

Each control channel element may consist of a number of resource blocks. The resource blocks of each control channel element may be arranged in the form of j consecutive resource blocks in frequency domain and k consecutive symbols in time domain, wherein i=j*k corresponds to the number of resource element groups (REGs) of each control channel element.

According to 3GPP TS 38213 V16.3.0, the duration of the CORESET in time domain may be up to three OFDM symbols. The CORESET may have to support multiple of CCEs. One CCE may correspond to six (6) resource blocks, wherein each resource block consists of twelve (12) consecutive resource elements in frequency domain. Hence, one CCE is equivalent to 72 resource elements.

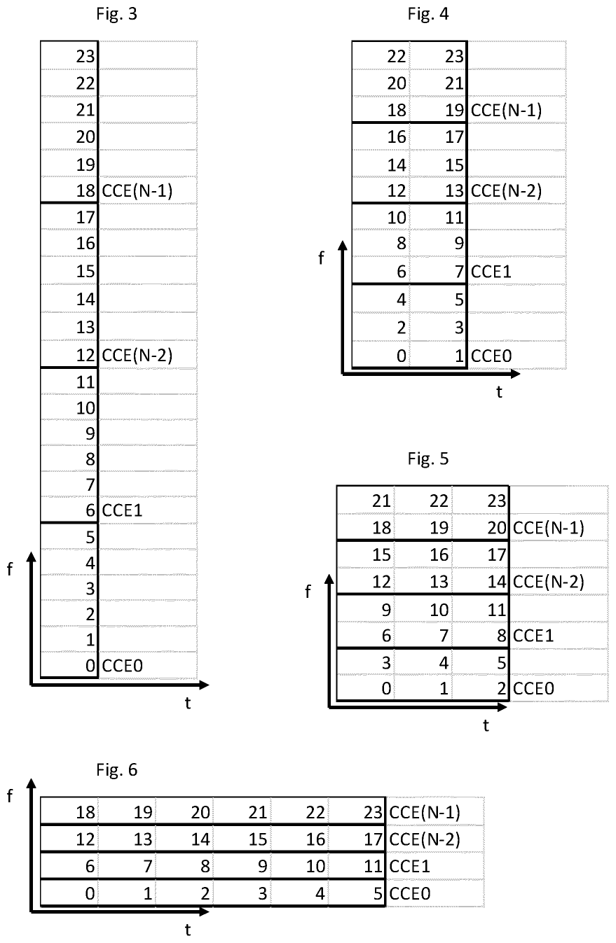

FIGS. 3 to 6 illustrates four possible arrangements of i=6 resource blocks of a given control channel element in time and frequency domain. The N CCEs CCE0, CCE1 to CCE(N-1) may correspond to consecutive frequency blocks in frequency domain.

For example, the resource blocks 1 to 6 may be provided as one (1) symbol in time domain comprising six (6) consecutive resource blocks in frequency domain (FIG. 3), as two (2) consecutive symbols in time domain each comprising three (3) consecutive resource blocks in frequency domain (FIG. 4), as three (3) consecutive symbols in time domain each comprising two (2) consecutive resource blocks in frequency domain (FIG. 5), and as six (6) consecutive symbols in time domain each comprising one (1) resource block in frequency domain.

As explained herein before, according to 3GPP TS 38213 V16.3.0, the duration of the CORESET in time domain may only be up to three OFDM symbols. Thus, the arrangement of FIG. 6 may not be possible to use in legacy networks. On the other hand, there may be a need to support wireless communication devices of a second wireless device type having reduced capabilities, in particular, wireless communication devices having limited bandwidth capability and/or limited antenna size and/or fewer number of antennas. Referring to FIGS. 3 to 6, there may be a need for supporting wireless communication devices which have limited bandwidth capabilities. For example, the bandwidth may be limited to only twelve (12) consecutive resource blocks in frequency domain. Thus, the wireless communication devices of the second wireless device type may not be able to use the arrangement of FIG. 3.

The proposed methods allow for supporting wireless devices of a first wireless device type and a second wireless device type. In particular, the proposed method allows for providing first resources for the first wireless device type and second resources for the second wireless device type.

The first resources may comprise a first number of consecutive symbols and the second resources may comprise a second number of consecutive symbols, wherein the second number of consecutive symbols is larger than the first number of consecutive symbols.

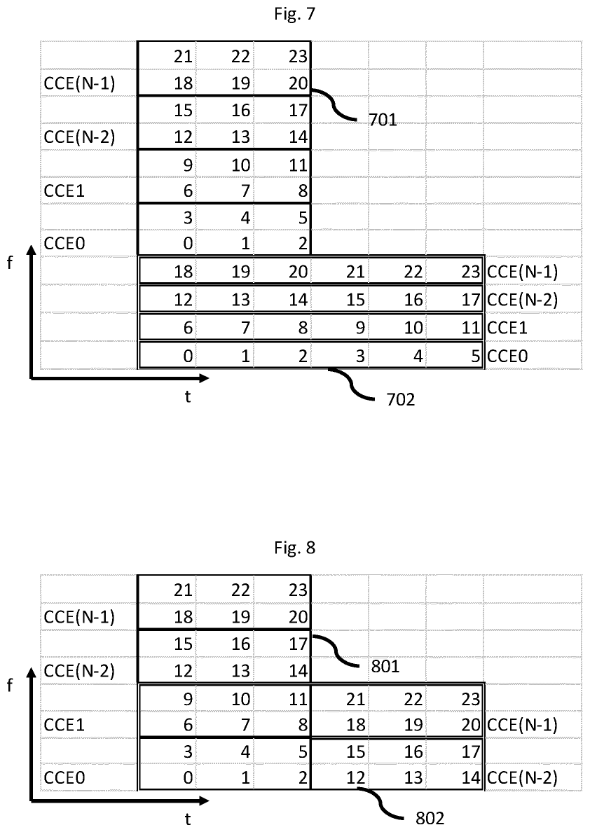

For example, as shown in FIG. 7, the first resources 701 may comprise three consecutive symbols and the second resources 702 may comprise six consecutive symbols. In the example shown in FIG. 7, the first resources 701 and the second resources 702 are disjoint. The first resources 701 and the second resources 702 do not overlap.

The first resources may comprise a first number of consecutive frequency resource blocks and the second resources may comprise a second number of consecutive frequency resource blocks, wherein the second number of consecutive frequency resource blocks is smaller than the first number of consecutive frequency resource blocks.

In the example of FIG. 7, the first resources 701 comprise eight (8) consecutive resource blocks and the second resources 702 comprise four (4) consecutive resource blocks.

In examples, the first resources and the second resources may at least partly overlap. This may reduce the overall resource consumption for supporting wireless communication devices of a first wireless device type and a second wireless device type. FIG. 8 illustrates a scenario in which the first resources 801 and the second resources 802 share the CCEs CCE0 and CCE2. However, the CCEs CCE(N-2) and CCE(N-1) are provided at different locations of the time-frequency grid.

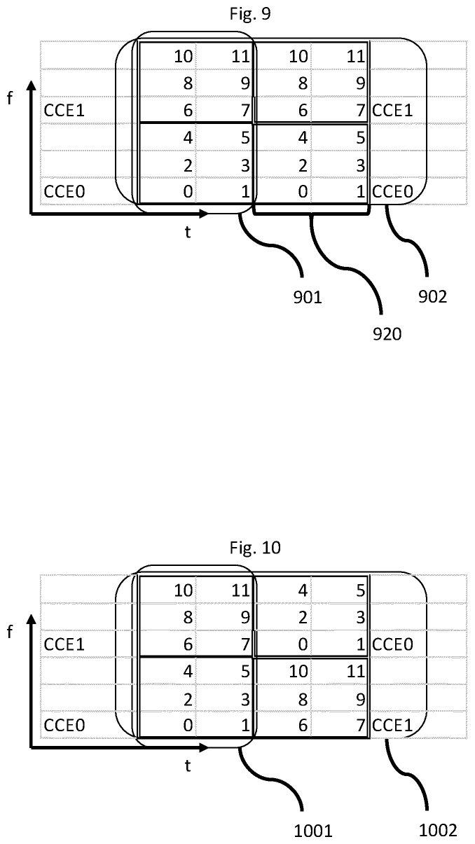

According to examples, transmitting, by the control channel, by the access node, the control channel using the second resources comprises redundantly transmitting the control channel. Redundantly transmitting the control channel may render the transmission of the control channel more robust. This can also be interpreted as repetitive transmission. Accordingly, wireless communication devices of the second wireless device type may get along with a fewer number of antennas or reduced size compared to devices of the first wireless device type. For example, as shown in FIGS. 9 and 10, the second resources 902, 1002 may allow for transmitting two times the CCEs CCE0 and CCE1, whereas the first resources 901, 1001 may allow for only transmitting one time the CCEs CCE0 and CCE1.

As shown in FIG. 9, the second number of symbols of the second resources 902 may comprise a repetition of a group 920 of consecutive symbols. As shown in FIG. 10, the second resources may allow for multiplexing of multiple CCEs in time and frequency domain.

The control channel may contain a configuration of a data channel. For example, the control channel PDCCH may contain the configuration of the data channel PDSCH. The configuration of the data channel may indicate the physical resources (for example, time and frequency resources) for transmitting data on the data channel time and/or a modulation scheme used for transmitting data on the data channel.

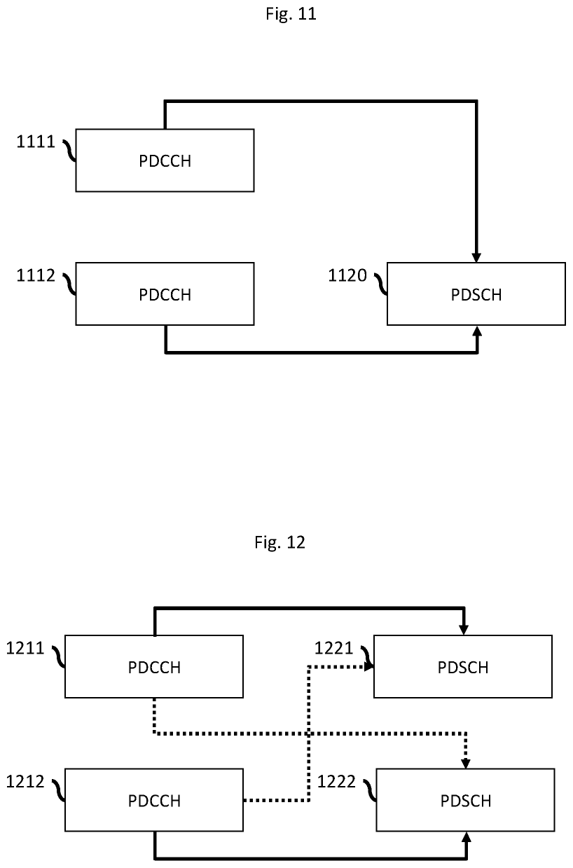

FIG. 11 illustrates that the control channel (e.g., PDCCH) may be transmitted using first resources 1111 and second resources 1112. The control channel may contain the configuration for a data channel (e.g., PDSCH) 1120, on which the respective wireless communication device may receive data. The configuration may be the same for both wireless device types. Providing only one configuration for both wireless device types may reduce the amount of resources to be allocated by the network.

FIG. 12 illustrates that the control channel (e.g., PDCCH) may be transmitted using first resources 1211 and second resources 1212. The control channel may contain the configuration of a first data channel (e.g., PDSCH) 1221, on which a wireless communication device of a first wireless device type may receive data, and the configuration of a second data channel (e.g., PDSCH) 1222, on which a wireless communication device of a second wireless device type may receive data. A wireless communication device of the first (second) wireless device type may decide to discard the configuration relating to the second data channel 1222 (first data channel 1221).

As explained above, the first resources 1111, 1121 and second resources 1221 and 1212 may be disjoint as indicated in FIGS. 11 and 12 for simplification purposes but may also overlap. Likewise, the first data channel 1221 and the second data channel 1222 may at least partly overlap. For example, the second data channel 1222 may comprise the first data channel 1221 and additional resources, e.g., a repetition of the first data channel 1221.

In examples, the control channel may comprise a configuration of a first data channel which may be associated with wireless communication devices of the first wireless device type and the second wireless device type. In this scenario, wireless communication devices of the first wireless device type and the second wireless device type may use the same physical resources and/or the same modulation scheme for receiving data on the first data channel. This may have the advantage to require less resources within the communication network.

In other examples, the control channel may comprise a configuration of a first data channel which is associated with a wireless communication device of the first wireless device type and a configuration of a second data channel which is associated with a wireless communication device of a second wireless device type. In this scenario, the wireless communication devices may use different physical resources (and optionally different modulation schemes) for receiving data on the first data channel and the second data channel. Thus, the configuration of the first data channel and the configuration of the second data channel may be optimized for the respective first wireless device type and the second wireless device type.

As explained hereinbefore with respect to the field(s) of the message indicating the resources for transmitting the control channel, the control channel may also comprise a single field for transmitting both configurations or separate fields for transmitting the configurations.

According to examples, the indication of control channel can be differently depending on the search space sets type.

For scenarios corresponding to Type-0 of the legacy system, the resources for the control channel are indicated using PBCH. The PBCH size may be quite limited and transmitting a dedicated PBCH for wireless communication devices having limited capabilities may not be efficient. Inside PBCH, indexing may be used for the CORESET configuration table and the search space set configuration table. It is proposed to configure wireless communication devices having limited capabilities using the same indexing mechanism, but the wireless communication devices having limited capabilities may interpret the respective index differently. This may be either explicitly expressed in the tables or may be derived from a set of rules or formula.

For example, if the selected CORESET configuration table is index 12, the legacy wireless communication device may interpret that as a number of 96 resource blocks but the wireless communication device having reduced capabilities may interpret that as a number of 48 resource blocks.

If the bandwidth required for transmitting the control channel according to the legacy configuration is smaller than bandwidth supported by the wireless communication device having reduced capabilities, the additional available frequency resources may be used to support a higher aggregation level or a repetition in the frequency domain to compensate for limited antenna functionality of the wireless communication device having reduced capabilities.

For scenarios corresponding to Type-OA of the legacy system, the CORESET and common search space configuration may be done separately when they are broadcasted via SIB1. In the alternative, they may be provided within the same field as additional parameters required for wireless communications devices with reduced capability may be included in the extra configuration.

In scenarios corresponding to Type-1, the proposed method may be used for the PRACH operation (Msg2, Msg4). The CORESET and common search space configuration may be done separately when they are broadcasted via SIB1. The max. duration of the time window to monitor for PDCCH of msg2 may be adjusted, in particular extended, accordingly. Alternatively, the same field may be used for wireless communication devices of the first device type and the second device type, but additional parameters may to support the extra configuration needed for the second device type having reduced capabilities.

In scenarios corresponding to Type-2 of the legacy system, the method disclosed herein may be used for paging reception. The CORESET and common search space configuration may be done separately for the first wireless device type and the second wireless device type. In the alternative, the same field may be used for the first wireless device type and the second wireless device type and additional parameters are included for the extra configuration needed to support second wireless device type.

In scenarios corresponding to Type-3 of the legacy system, which relate to wireless communication device specific signalling, legacy procedures may be used for wireless communications devices of the first wireless device type and the second wireless device type. It may be assumed that the access node is aware of the capabilities of the wireless communication device and may allocate the resources accordingly.

In scenarios of bad coverage, a wireless communication device of the first wireless device type may decide to operate according to a wireless communication device of the second wireless device type and provide a respective indication to the access node.

Summarizing, at least the following examples have been described above:

EXAMPLE 1. A method of operating an access node, AN, comprising
broadcasting, by the AN, a message indicative of resources for transmitting a control channel, in particular a control channel associated with a communication standard (e.g., NR and/or 6G), wherein the message is indicative of first resources and second resources for transmitting the control channel, wherein the first resources are associated with a first wireless device type, and wherein the second resources are associated with a second wireless device type, which has reduced capabilities in relation to the first wireless device type; and
transmitting, by the AN, the control channel using the first resources and the second resources.

EXAMPLE 2. The method of operating the AN of EXAMPLE 1,

wherein the message comprises a field for the first resources and an additional field for the second resources.

EXAMPLE 3. The method of operating the AN of EXAMPLE 1,

wherein the message comprises one field for both the first resources and the second resources.

EXAMPLE 4. The method of operating the AN of any one of EXAMPLEs 1 to 3,

wherein the first resources comprise a first number of consecutive symbols, in particular a first number of consecutive OFDM symbols,

wherein the second resources comprise a second number of consecutive symbols, in particular a second number of consecutive OFDM symbols,

wherein the second number of consecutive symbols is larger than the first number of consecutive symbols.

EXAMPLE 5. The method of operating the AN of any one of EXAMPLEs 1 to 4,

wherein transmitting, by the AN, the control channel using the second resources comprises redundantly transmitting the control channel using the second resources.

EXAMPLE 6. The method of operating the AN of any one of EXAMPLEs 4 or 5, wherein the second number of consecutive symbols comprises a repetition of a group of consecutive symbols.

EXAMPLE 7. The method of operating the AN of any one of EXAMPLEs 1 to 6,

wherein the first resources comprise a first number of consecutive frequency resource blocks,

wherein the second resources comprise a second number of consecutive frequency resource blocks,

wherein the second number of consecutive frequency resource blocks is smaller than the first number of consecutive frequency resource blocks.

EXAMPLE 8. The method of operating the AN of any one of EXAMPLEs 1 to 7,

wherein the first resources and the second resources at least partly overlap.

EXAMPLE 9. The method of operating the AN of any one of EXAMPLEs 1 to 8,

wherein the first resources and the second resources are disjoint.

EXAMPLE 10. The method of operating the AN of any one of EXAMPLEs 1 to 9,

wherein the control channel comprises a configuration of a first data channel, wherein the first data channel is optionally associated with a wireless communication device of the first wireless device type.

EXAMPLE 11. The method of operating the AN of EXAMPLE 10,

wherein the control channel comprises a configuration of a second data channel.

the second data channel is optionally associated with a wireless communication device of the second wireless device type.

EXAMPLE 12. The method of operating the AN of EXAMPLE 10 or 11,

wherein the configuration of the first and/or second data channel is indicative of at least one of:
a physical resource used for transmitting data on the first or second data channel,
a modulation scheme used for transmitting data on the first or second data channel.

EXAMPLE 13. The method of operating the AN of EXAMPLE 11 or 12, wherein the first data channel and the second data channel at least partly overlap, in particular wherein the first data channel and the second data channel are identical.

EXAMPLE 14. The method of operating the AN of EXAMPLE 11 or 12,

wherein the first data channel and the second data channel are disjoint.

EXAMPLE 15. The method of operating the AN of any one of EXAMPLEs 1 to 14,

wherein the message is indicative of at least one of
a location of the first resources in frequency and/or time;
a location of the second resources in frequency and/or time;
a location of the first resources in frequency and/or time in relation to a location of the second resources in frequency and/or time;
a multiplexing scheme of the first resources; and/or
a redundancy of the first resources.

EXAMPLE 16. A method of operating a wireless device, UE, comprising
receiving, from an access node, AN, a message indicative of resources for receiving a control channel, in particular a control channel associated with a communication standard (e.g. NR and/or 6G),

wherein the message is indicative of first resources and second for receiving the control channel, wherein the first resources are associated with a first wireless device, and wherein the second resources are associated with a second wireless device type, which has reduced capabilities in relation to the first wireless device type;
monitoring the first resources if the wireless device implements a first wireless device type,
monitoring the second resources if the wireless device implements a second wireless device type.

EXAMPLE 17. The method of operating the UE of EXAMPLE 16, the method further comprising:
determining the first resources based on a field of the message and a lookup table.

EXAMPLE 18. The method of operating the UE of EXAMPLE 17, the method further comprising:
determining the second resources based on the field of the message and a lookup table.

EXAMPLE 19. The method of operating the UE of EXAMPLE 16 or 17, the method further comprising:
determining the second resources based on an additional field of the message.

EXAMPLE 20. The method of operating the UE of any one of EXAMPLEs 16 to 19, the method further comprising:
selecting, by the UE, to implement a first wireless device type or a second wireless device type based on a predetermined criteria.

EXAMPLE 21. An access node, AN, comprising circuitry configured for causing the AN
to broadcast a message indicative of resources for transmitting a control channel, in particular a control channel associated with a communication standard (e.g. NR and/or 6G), wherein the message is indicative of first resources and second resources for transmitting the control channel, wherein the first resources are associated with a first wireless device type, and wherein the second resources are associated with a second wireless device type, which has reduced capabilities in relation to the first wireless device type; and
to transmitting the control channel using the first resources and the second resources.

EXAMPLE 22. An access node, AN, in particular the AN of EXAMPLE 21, wherein a or the control circuitry of the AN is configured for causing the AN to perform the method of any one of EXAMPLEs 1 to 15.

EXAMPLE 23. A wireless device, UE, comprising circuitry configured for causing the UE
to receive, from an access node, AN, a message indicative of resources for receiving a control channel, in particular a control channel associated with a communication standard (e.g. NR and/or 6G), wherein the message is indicative of first resources and second resources for receiving the control channel, wherein the first resources are associated with a first wireless device type, and wherein the second resources are associated with a second wireless device type, which has reduced capabilities in relation to the first wireless device type;
to monitor the first resources if the wireless device implements a first wireless device type,
to monitor the second resources if the wireless device implements a second wireless device type.

EXAMPLE 24. A wireless communication device, UE, in particular the UE of EXAMPLE 23,

wherein a or the control circuitry of the UE is configured for causing the UE to perform the method of any one of EXAMPLEs 16 to 20.

1. A method of operating an access node (AN) comprising
broadcasting, by the AN, a message indicative of resources for transmitting a control channel, wherein the message is indicative of first resources and second resources for transmitting the control channel, wherein the first resources are associated with a first wireless device type, and wherein the second resources are associated with a second wireless device type, which has reduced capabilities in relation to the first wireless device type; and
transmitting, by the AN, the control channel using the first resources and the second resources.

2. The method of operating the AN of claim 1,
wherein the message comprises a field for the first resources and an additional field for the second resources.

3. The method of operating the AN of claim 1,
wherein the message comprises one field for both the first resources and the second resources.

4. The method of operating the AN of claim 1,
wherein the first resources comprise a first number of consecutive symbols, in particular a first number of consecutive OFDM symbols,
wherein the second resources comprise a second number of consecutive symbols, in particular a second number of consecutive OFDM symbols,
wherein the second number of consecutive symbols is larger than the first number of consecutive symbols.

5. The method of operating the AN of claim 1,
wherein transmitting, by the AN, the control channel using the second resources comprises redundantly transmitting the control channel using the second resources.

6. The method of operating the AN of claim 4,
wherein the second number of consecutive symbols comprises a repetition of a group of consecutive symbols.

7. The method of operating the AN of claim 1,
wherein the first resources comprise a first number of consecutive frequency resource blocks,
wherein the second resources comprise a second number of consecutive frequency resource blocks,
wherein the second number of consecutive frequency resource blocks is smaller than the first number of consecutive frequency resource blocks.

8. The method of operating the AN of claim 1,
wherein the first resources and the second resources at least partly overlap.

9. The method of operating the AN of claim 1,
wherein the first resources and the second resources are disjoint.

10. The method of operating the AN of claim 1,
wherein the control channel comprises a configuration of a first data channel.

11. The method of operating the AN of claim 10,
wherein the control channel comprises a configuration of a second data channel.

12. The method of operating the AN of claim 10,
wherein the configuration of the first and/or second data channel is indicative of at least one of:
a physical resource used for transmitting data on the first or second data channel,
a modulation scheme used for transmitting data on the first or second data channel.

13. The method of operating the AN of claim 1,
wherein the message is indicative of at least one of
a location of the first resources in frequency and/or time;
a location of the second resources in frequency and/or time;
a location of the first resources in frequency and/or time in relation to a location of the second resources in frequency and/or time;
a multiplexing scheme of the first resources; and/or
a redundancy of the first resources.

14. A method of operating a wireless device (UE) comprising
receiving, from an access node (AN) a message indicative of resources for receiving a control channel,
wherein the message is indicative of first resources and second for receiving the control channel, wherein the first resources are associated with a first wireless device, and wherein the second resources are associated with a second wireless device type, which has reduced capabilities in relation to the first wireless device type;
monitoring the first resources if the wireless device implements a first wireless device type,
monitoring the second resources if the wireless device implements a second wireless device type.

15. The method of operating the UE of claim 14, the method further comprising:
determining the first resources based on a field of the message and a lookup table.

16. The method of operating the UE of claim 15, the method further comprising:
determining the second resources based on the field of the message and a lookup table.

17. The method of operating the UE of claim 14, the method further comprising:
determining the second resources based on an additional field of the message.

18. The method of operating the UE of claim 14, the method further comprising:
selecting, by the UE, to implement a first wireless device type or a second wireless device type based on a predetermined criteria.

19. An access node (AN) comprising circuitry configured for causing the AN
to broadcast a message indicative of resources for transmitting a control channel, wherein the message is indicative of first resources and second resources for transmitting the control channel, wherein the first resources are associated with a first wireless device type, and wherein the second resources are associated with a second wireless device type, which has reduced capabilities in relation to the first wireless device type; and
to transmitting the control channel using the first resources and the second resources.

20. The AN of claim 19,
wherein a or the control circuitry of the AN is configured for causing the AN to perform the method of claim 1.

21-22. (canceled)
